(19) United States
(12) Patent Application Publication
(10) Pub. No.: US 2013/0244776 A1
(43) Pub. Date: Sep. 19, 2013

(54) Method and Apparatus for Mobile Gaming Using Real World Locations

(71) Applicants: Bryan C. Everly, Indianapolis, IN (US); James C. Felli, Indianapolis, IN (US)

(72) Inventors: Bryan C. Everly, Indianapolis, IN (US); James C. Felli, Indianapolis, IN (US)

(73) Assignee: CELINAR GAMES, LLC, Indianapolis, IN (US)

(21) Appl. No.: 13/615,584

(22) Filed: Sep. 13, 2012

Related U.S. Application Data
(60) Provisional application No. 61/534,295, filed on Sep. 13, 2011.

(51) Int. Cl. A63F 13/00

(52) U.S. Cl. CPC A63F 13/00
USPC 463/31

(57) ABSTRACT

A method includes a step of transmitting from a wireless device first location information indicating a real-world physical location of the wireless device. The method also includes receiving at the wireless device update data including first information comprising location information for a plurality of entities in a real world coordinate system, the update further comprising a state value for each of the plurality of entities. The method further includes rendering on a display of the wireless device a representation of the location and state value of the plurality of entities in a real-world coordinate system in relation to the real-world physical location of the wireless device. The method also includes receiving a user input at the wireless device, and generating second information therefrom, and transmitting the second information to a remote device. The second information provides state value change information relating to at least one of the plurality of entities.

This application claims the benefit of U.S. Provisional Patent Application Ser. No. 61/534,295, filed Sep. 13, 2011, and which is incorporated herein by reference.

### FIELD OF THE INVENTION

The present invention relates generally to games playable on portable wireless devices.

### BACKGROUND OF THE INVENTION

Downloadable applications for portable wireless devices, such as wireless phones, are known. Many downloadable applications consist of games that may be played on the wireless device. To obtain such applications, users may employ their wireless phones to purchase or otherwise download the applications from a remote server, such as an ITUNES® application server. ITUNES® is a registered trademark of Apple, Inc.

Many games involve manipulations of graphic elements on a wireless device screen. There is a need for games involving more interactivity with the environment around the user. Such interactivity can lead to more socialization, and more physical exercise while immersed in the gaming environment.

### SUMMARY

The present invention addressed one or more of the above-referenced needs, as well as others, by providing arrangements, methods and apparatus for providing, playing and facilitating games that involve physical movement and mobile devices. Various exemplary embodiments are described herein.

A first embodiment is a method that includes a step of transmitting from a wireless device first location information, the first location information comprising information indicating a real-world physical location of the wireless device. The method also includes receiving at the wireless device update data, the update data including first information comprising location information for a plurality of entities in a real world coordinate system, the update further comprising a state value for each of the plurality of entities. The method further includes rendering on a display of the wireless device a representation of the location and state value of the plurality of entities in a real-world coordinate system in relation to the real-world physical location of the wireless device. The method also includes receiving a user input at the wireless device, and generating second information therefrom, and transmitting the second information to a remote device. The second information provides state value change information relating to at least one of the plurality of entities.

The above-described features and advantages, as well as others, will become more readily apparent to those of ordinary skill in the art by reference to the following detailed description and accompanying drawings.

### BRIEF DESCRIPTION OF THE DRAWINGS

FIG. 1 shows a schematic block diagram arrangement 10 for carrying out a gaming system using real-world locations in accordance with an exemplary embodiment of the invention;

FIG. 2 shows a functional block diagram of a wireless device configured to carry out at least some embodiments of the invention;

FIG. 3 shows a flow diagram of operations of various elements of FIG. 1;

FIG. 4 shows a flow diagram of a first exemplary set of operations of a processing circuit of a first wireless device in accordance with a first embodiment;

FIG. 5 shows flow diagrams of an exemplary set of operations of a processing circuit of a first wireless device and a server processor in accordance with one or more embodiments;

FIG. 6 shows a flow diagram of another exemplary set of operations of the processing circuit and server processor in accordance with one or more embodiments;

FIG. 7 shows an exemplary display screen in accordance with a first embodiment of the invention; and

FIG. 8 shows an exemplary data record for a player associated with the wireless device of FIG. 2.

### DETAILED DESCRIPTION

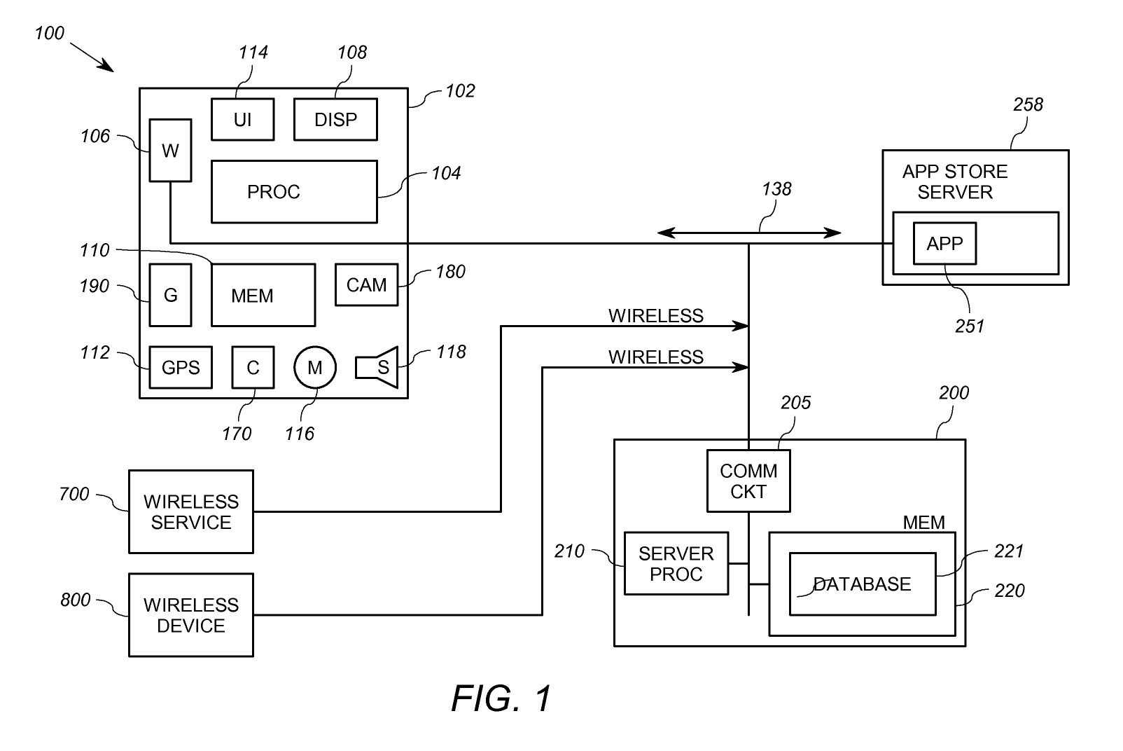

FIG. 1 shows a schematic block diagram of an arrangement 10 for carrying out a gaming system using real-world locations. The arrangement 10 includes at least a first wireless device 100, a game server 200, and an application store server 250. The arrangement 10 in many embodiments is intended for use with multiple interactive players, and therefore can include additional wireless devices 700, 800. It will be appreciated that at least some embodiments can involve hundreds, thousands or even million players and may be considered massively multiplayer. However, for purposes of clarity of exposition, the structure and operation of the arrangement 10 is described with three exemplary wireless devices 100, 700, and 800, corresponding to first, second and third players. It will also be appreciated that in at least some embodiments, the arrangement 10 allows for solo game play.

The wireless device 100 includes a housing 102, a processing circuit 104, a wireless communication circuit 106, a display 108, memory 110, a global positioning system circuit 112 (is this separate), at least one user input device 114, a microphone 116 and a speaker 118. For purposes of the present invention, not all of the above components are required. At a minimum, the wireless device 100 should include the housing 102, the processing circuit 104, the wireless communication circuit 106, the display 108, memory 110, the global positioning system circuit 112, and the user input device 114. It will be appreciated that the wireless device 100 may suitably be an iPhone 4 model smart phone available from Apple, Inc.

In general, the wireless device 100 is capable of electronic communication with other devices such as the game server 200, the application store server 250, and other wireless devices 700, 800. Such communication may suitably occur through a hardwire connection, a network connection, or a wireless connection, or a combination of both, using the wireless communication circuit 106 and a cellular or WiFi connection. Any suitable, conventional method of providing wireless communications to a smart phone wireless device may be employed.

The wireless devices 700, 800 may suitably have the same or similar structure as the wireless device 100. Moreover, one of ordinary skill in the art will appreciate that one or more of wireless devices 100, 700, 800 can take many different forms, and are thus not limited by the particular description and illustration herein. Rather, the wireless devices can have many different but analogous structures. As such, the present invention is by no means limited by the particular example embodiments or specific platform described and depicted herein, but includes all reasonable equivalents having the necessary functionality to implement the method of the present invention.

The general structure of the wireless device 100 is conventional of commercially available smart phone devices. In general, the processing circuit 104 is operably connected to the wireless communication circuit 106 to effectuate communication data to and from external devices via either the cellular network or the Internet via a WIFI connection and network interface. The processing circuit 104 is operably connected to cause the display 108 to display data, images or graphics. The processing circuit 104 is also operably connected to memory 110 to store data thereto, and retrieve data therefrom. The processing circuit 104 is operably connected to cooperate with the global positioning system circuit 112 to obtain approximate geographical coordinates of the wireless device 100 as is known in the art. Finally, the processing circuit 104 is operably coupled to the user input device 114 to obtain user input therefrom. In the embodiment described herein, the user input device 114 and the display 108 may be embodied as a touchscreen subsystem, as is known in the art. The user input device 114 may include additional controls or buttons in addition to the touchscreen subsystem.

In at least some embodiments, the wireless device 100 further includes a compass device 170, a camera 180, and gyroscope 190. Such features are known in smart phones such as the iPhone 4. The compass device 170 is device configured to provide signals representative of the orientation of the wireless device 100 (i.e. housing 102) with respect to geographical directions of north, south, east and west. The camera 180 includes an optical sensor unit capable of generating image signals representative of detected images. Such devices are well-known and widely implemented on wireless devices. The gyroscope 190 is configured to generate signals representative of various forces on the wireless device 100, such as acceleration from changes in movement, acceleration and deceleration.

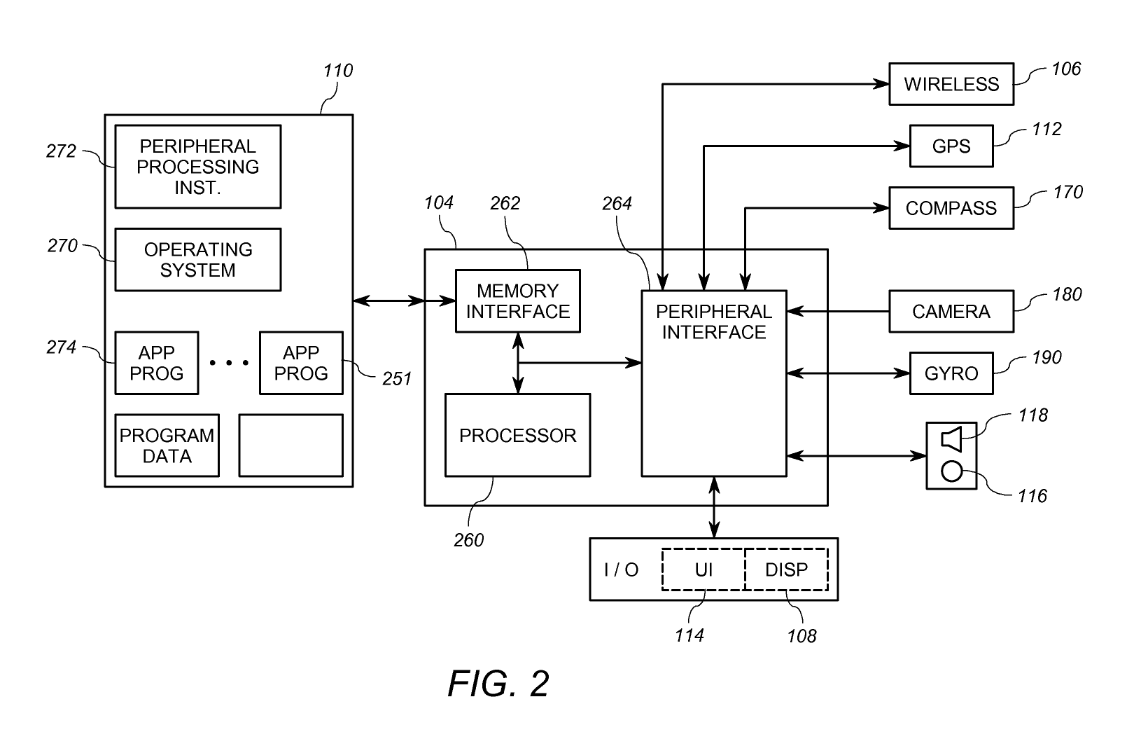

FIG. 2 shows an exemplary embodiment of the wireless device 100 in further detail. As shown in FIG. 2, the processing circuit 104 includes at least one processor 260, a memory interface circuit 262 and a peripheral interface circuit 264. The memory interface 262 is operably coupled to the memory 110. The memory interface 262 is a conventional circuit configured to provide access to the memory 110. To this end, the memory interface 262 is further coupled to the processor 260 and the peripheral interface 264.

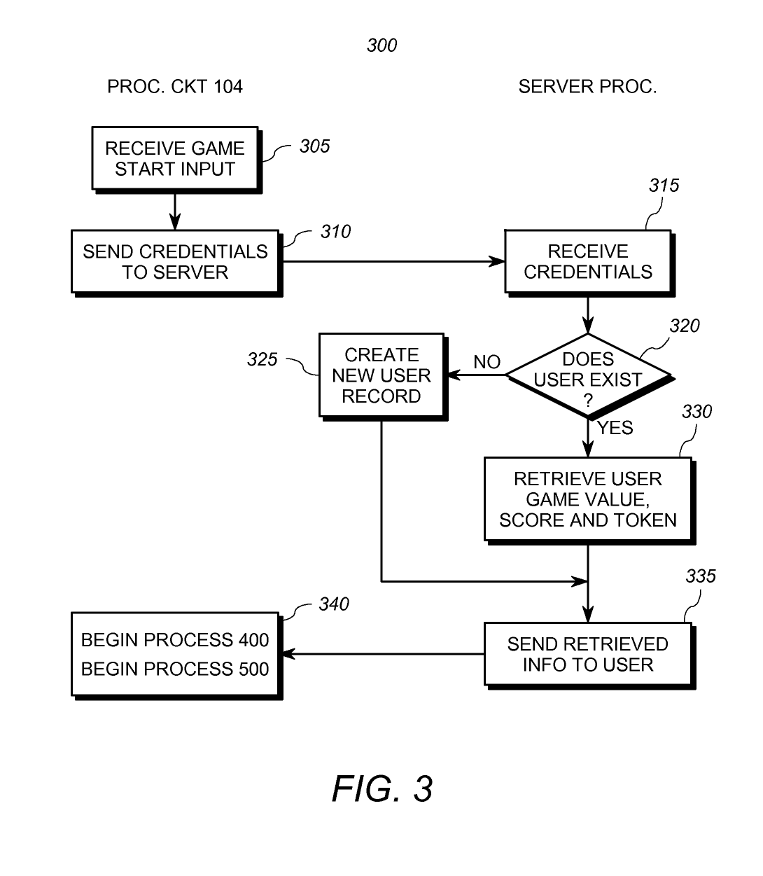

The processor 260 is configured to execute programming instructions obtained from the memory 110 via the memory interface 262 in order to carry the operations attributed to the processing circuit 104 herein, such as in connection with the operations of FIGS. 3 to 6. The peripheral interface circuit 264 is a circuit that is configured to facilitate communication of information between the processor 260 and the various peripheral devices, such as the wireless communication circuit 106, the GPS device 112, the compass 170, the camera 180, the gyroscope 190, the microphone 116, the speaker 118, and the I/O elements such as the display 108 and the user input device 114.

As also shown in FIG. 2, the memory 110 as described herein includes programming instructions and program data. The programming instructions include the operating system 270, the peripheral processing instructions 272, and one or more application 274, including the application 251. Depending on specific implementation requirements, the memory 110 may include a computer system memory or random access memory (RAM), such as dynamic RAM (DRAM), static RAM (SRAM), extended data out RAM (EDO RAM), etc. The memory 110 may include other types of memory as well, or combinations thereof.

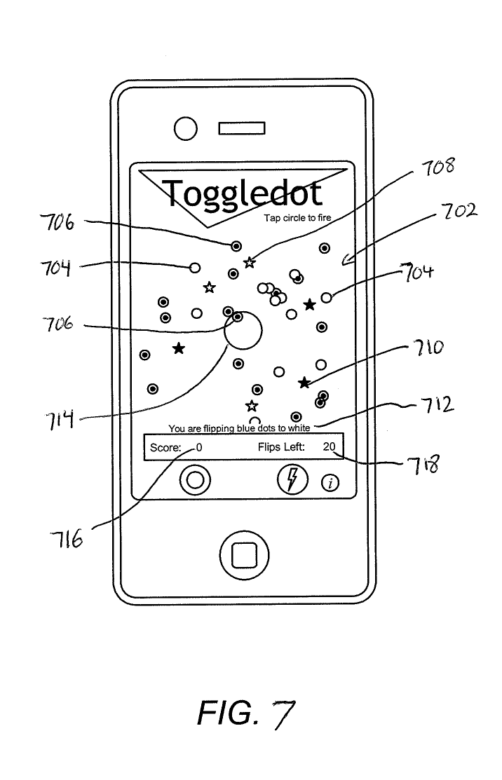

The operating system 270 provides the general processing environment for the processor 260. The peripheral processing instructions 272 include software elements that form interfaces/drivers to the various physical peripheral devices 106, 108, 112, 114, 116, 118 170, 180, 190 in the wireless device 100, as is known in the art. The operating system 270 provides an environment in which the applications 251, 274 may utilize the peripheral devices 106, 108, 112, 114, 116, 118 170, 180, 190 of the wireless device 110 through the peripheral processing instructions 272. It will be appreciated that the programming environment in the commercially available iPhone 4, depicted in FIG. 2, is known in the art. An analogous architecture is known for wireless devices that implement that Android operating system as well. Further details of the interfaces between the operating system and the various physical devices are omitted for clarity of exposition, as such interfaces would be known to those of ordinary skill in the art. Publicly available programming environment information identifies how to use such interfaces. Reference is further made to FIG. 7 and the accompanying description of U.S. Patent Publication No. 2010/0070758, which is incorporated herein by reference.

In the general operation of FIG. 2, the processor 260 can execute the various programming instructions 251, 270 and 272 to implement the game application 251 described herein. The application 251 (as executed by the processor 260) may obtain access, which includes the ability to receive information from, and provide information to, the various peripheral devices, such as the display 108, the user input 114, the camera 180, the GPS device 112, the compass 170, and the gyroscope 190, using the operating system 270 and the peripheral processing instructions 272.

Referring again to FIG. 1, the game server 200 includes a communication circuit 205, a server processor 210 and a server data store 220. The server processor 210 may suitably be one or more processing circuits of a commercially available server computer. The server data store 220 stores a database 221 that includes records for each registered user of the application 251, whether or not the application 251 is currently running for that user.

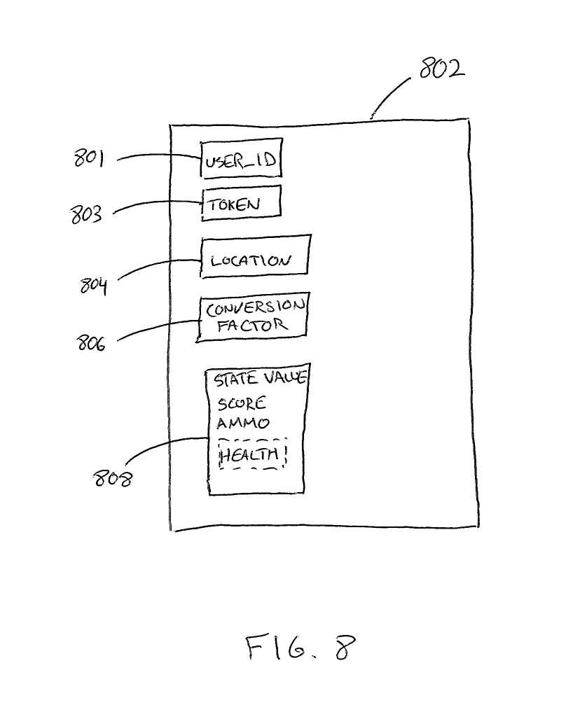

FIG. 8 shows a representative diagram of an exemplary user record 802 stored in the database 221 of FIG. 2. Each user record 802 is associated with a player of the game. Each user record 802 includes, at a minimum, location data 804 indicating the user's (e.g. wireless device 100) most recent location in geographic coordinates, a conversion factor 806 of geographical coordinates to meter distances for the user, at least one game state value 808 for the user. The record may suitably include a user identification value 801 and a token value TOKEN 803, which are used as discussed below. The at least one game state value 808 can include one or more player parameters associated with the user, such as an identity of the “team” or “faction” to which the player belongs, a “health” value, an “ammunition” value, a “score” value, and/or one or more game enhancements. The health value, for example, may suitably be a quantitative measure of the life force of the player. The ammunition value, for example, may include the number of shots, bullets or other attacks the player has within the game. In general, a player consumes shots by “attacking” other entities in the game, and loses “health” when other entities successfully attack the player. Successful attacks of other entities can result in increasing the “score” value.

It will be appreciated that the user record 802 may suitably include more or less values, depending on game play. For example, the user record 802 may further include indications of any upgraded offensive or defensive enhancements based on purchased upgrades. For example, a user may be able to purchase an enhancement that makes it harder to be “hit” in combat, or easier to “hit” an opponent during combat. Such enhancements are purchased using normal download/purchase exchanges with the application store server 251. Once purchased, the enhancements are stored in suitable data fields of the data record 802, not shown in FIG. 8.

Referring again to FIG. 1, the server processor 210 is further coupled (e.g. via a communication link or wired network) to the wireless communication device 205. The wireless communication device 205 is configured in a conventional manner to exchange data wirelessly with the device 100, as well as the devices 700 and 800.

In general, the arrangement 10 operates in the following manner. As an initial matter, the game application 251 is downloaded from the application store server 250 via a communication link 138, such as a wireless network link, or via any Internet link. Thereafter, the processing circuit 104 stores the application 251 in the memory 110. As is known in the art, the processing circuit 104 causes, via the operating system 270, an icon, not shown, to be displayed on the display 108 of the first wireless device 100. The icon relating the application 251 may suitably be one of a plurality of application icons that are selectable by the user via the user input 114. As discussed above, the display 108 and the user input 114 may be implemented as a touch screen display, wherein icons appear on the display 108 and the user may “select” an icon by touching the display 108 in the position of the icon. Selection of such an icon results in launching execution of the corresponding application.

When the user of the wireless device 100 then selects an icon related to the application 251, the processing circuit 104 executes the application 251. In particular, the processing circuit 104 (executing the application 251) and the game server 200 cooperate to carry out the operations of FIGS. 3, 4, 5, and 6. Those figures are discussed further below. However, in general, the processing circuit 104 and the game server 200 facilitate a game play experience that includes real-world geographical coordinates, movement of players, and interaction via wireless devices.

In one embodiment, the game includes two basic teams, factions or species, wherein each player is one of the two teams, and wherein players (and non-playing entities or “drones”) may be “flipped” from their existing team/faction to the other team/faction. As discussed above, identification of each player's faction or team value is stored as a game state value 808 in the data record 802 of FIG. 8. In one embodiment, a player is “flipped” when his or her “health” value is reduced to zero. Non-playing entities may operate the same way. One objective of each player is to “flip” as many entities as possible to advance a team score or an individual score.

During game play, the first wireless device 100 displays the relative locations of other player and non-playing entities. FIG. 7 shows a top plan view of the wireless device 100 displaying an exemplary gameplay screen 702. The screen 702 shows first entities 704 having a first game value or state, and second entities 706 having a second game value or state. In this embodiment, the entities 704 and 706 are representative of non-player entities, in other words, are not representative of other players. The screen 702 also shows third entities 708 having a first game value or state, and fourth entities 710 having a second game value or state. In this embodiment, the entities 708 and 710 represent other players in the game. It will be appreciated that in some alternative embodiments, the entities 704 and 708 may appear to be identical on the display screen 702, and entities 706 and 710 may appear to be identical on the display screen 702.

The locations of the entities 708 and 710 represent real-world positions of the other players in the games with respect to the wireless device 100. Other players' locations are dictated by the location of their respective wireless devices. For example, the entity 708 may be representative of the real world location of the wireless device 700 (belonging to another player), and the entity 710 may represent the real-world location of the wireless device 800 (belonging to yet another player). In both cases, the other players are executing the same game application 251 on their respective devices 700, 800. The non-player entities 704 and 706 represent real-world positions of entities, although the entities may not exist in the real-world. As will be discussed below, the locations of the non-player entities 704 and 706 may be randomly generated within the wireless device 100, or by the server 200, depending on the implementation. In the alternative, the non-player entities 704 and 706 may be persistent (i.e. stored at the server 200 and identical for all players) or temporarily created for each game session for each player individually.

In any event, the screen also has indicia 712 indicating the game state “team” or “faction” value of the user associated with the first wireless device 100. The screen also shows an indicator 714 of an area of effect. The indicator 714 corresponds to a predefined radius from the location of the user and/or wireless device 100, and as will be discussed below, represents the area that the user can affect (within the game) by “shooting”, “pulsing” or otherwise providing input to the wireless device. In addition, the screen 702 shows a “score” value 716 and an ammunition value 718. In this example, no separate “health” value is maintained. Instead, a single “hit” results in a state change from one “team” to another. In other embodiments, changing the state of the user (or opponent) may require several “hits” to reduce the health value to zero. In such a case, the screen 702 would also display the “health” value, either as a numeric value or as a graphic such as thermometer graphic or the like.

The basic combat scheme involves “hitting” entities within a predefined physical area of affect indicated by the indicator 714. Thus, in one form of the game, the user may “flip” or otherwise affect all entities within the area of effect. To do so, the user provides an appropriate entry on a predetermined icon 716 on the user input 114. The entry operates in the game as a “trigger” or “actuation” of a weapon or the like. In one embodiment, when the user input 114 receives such an input, all entities within the area of effect (as shown by indicator 714) are “flipped”, wherein their game value or state changes to the other game value or state. As discussed above, the position of each of the entities 704, 706, 708 and 710 is associated with a real geographic location. Accordingly, the user physically moves (i.e. moves the wireless device 100) toward the geographic locations associated with the entities 704, 706, 708 and 710 in order to bring one or more of the entities within the area of effect as noted by the indicator 714.

Hence, one aspect of the game is physical movement to pursue various entities, such as entities 704, 706, 708 or 710. In general, the goal of the game is to flip all of the entities having a different game value/team/faction to the user's game value/team/faction. When the user hits the input, all of the entities 704, 706, 708 and 710 that are within the area of influence are affected or flipped. Accordingly, the user ideally would want to physically move until only those entities of the opposing team/faction are disposed within the indicator 714, or in other words, such that the user is within a predetermined distance of the entities' real-world location. It will be appreciated, however, that in other embodiments, the user is not able to flip (or injure) people on the same team.

Accordingly, one of the features of the game, the player entities 708 and 710 move themselves, thereby allowing for some aspect of live and active pursuit. The user employs the screen 702 to determine the direction in which to move to bring opponent entities within the indicator 714.

It will be appreciated that the player using the wireless device 100 can also be the target of other players. To this end, other players (e.g. those executing the same game application on devices 700, 800) can flip or hit the user holding the wireless device 100, if the user/device 100 is within a predetermined distance of the other players/devices 700, 800. Thus, the game can have a speed competition element to it, as each player will try to flip the other before they are flipped (or hit).

As discussed above, in some embodiments, an opposing entity (and player on the device 100) can only be flipped if it is “hit” or several times. As discussed above, entities in such embodiments have a “health” value as well as a team/faction state value. Instead of flipping other entities, each player “hits” other entities to reduce the health value of such entities. For example, if the user activates the icon 716 while an entity 706 is within the area of influence (within indicia 714), the entity 706 may lose “health” points, but is not flipped to the other team/faction/game value. If the entity 706 subsequently loses all health points, the entity 706 may be resurrected with a different team/faction game value. It will be appreciated that the user also receives score (increases its score value) based on entities hit and/or flipped.

FIGS. 3 through 6 show a set of instructions that may be executed by the processing circuit 104 (executing the application 251) and the game server 200 to carry out the game play described above, as well as other variants of such game play.

FIG. 3 shows the general overall operations of the processing circuit 104 and the game server 200. In step 305, the processing circuit 104 receives an input selecting the game application 251. For example, the user may be provided with a set of selectable application icons, not shown, on the display 108 including one indicating the icon indicating the game application 251. In step 310, the processing circuit 104 sends game credentials to the server 200. The game credentials are typically part of the downloaded application 251 received from the game server 250. The credentials include user identification data that identifies the device 100 (i.e. its owner and game player) in a unique and persistent manner.

In step 315, the game server 200 receives the credentials from the processing circuit. Thereafter, in step 320, the game server 200 determines whether the user identified in the credentials is an existing player having a user record. If the game server 200 determines that the user does not exist, then the game server proceeds to step 325 to create a new user record (e.g. record 802 of FIG. 8). The new record 802 will include a set of default values for game state value GSV, and score SCORE. In an embodiment that involves a health value, the health value would also be stored in the new user record. As discussed above, in other embodiments, the new record can further include other default values. The new user record is stored in the database 220. In any event, the game server 200 thereafter proceeds to step 335.

If, however, the game server 200 determines in step 320 that the user already exists, then the game server 200 proceeds to step 330.

In step 330, the game server 200 retrieves the data record 802 associated with the user from the database 220. The retrieved data includes the game state value GSV for the user, the game score value SCORE for the user, and a digital token TOKEN. The game state value GSV identifies the “team” or “faction” with which the user is currently associated. In one embodiment, the GSV has one of two values, corresponding to one of the two teams or factions within the game. The value SCORE represents the user's score. The user gains SCORE values in various ways, but primarily including flipping (or damaging) entities from the other team or faction. The stored value VALUE retrieved in step 330 represents the user's score the last time. After retrieving the values GSV, SCORE and TOKEN for the user, game server 200 proceeds to step 335.

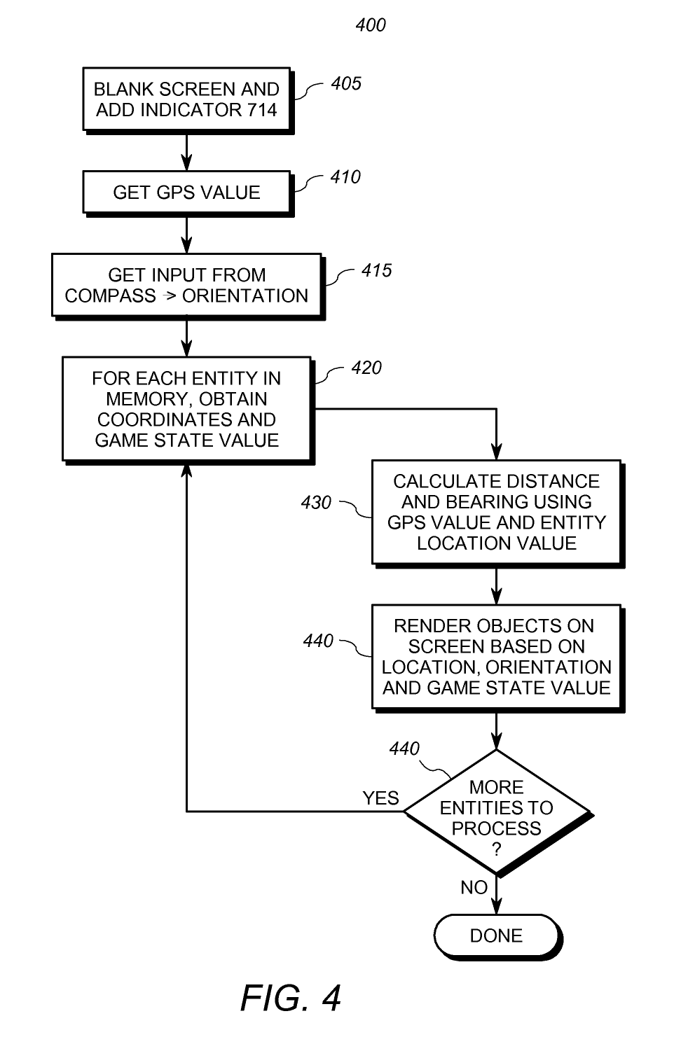

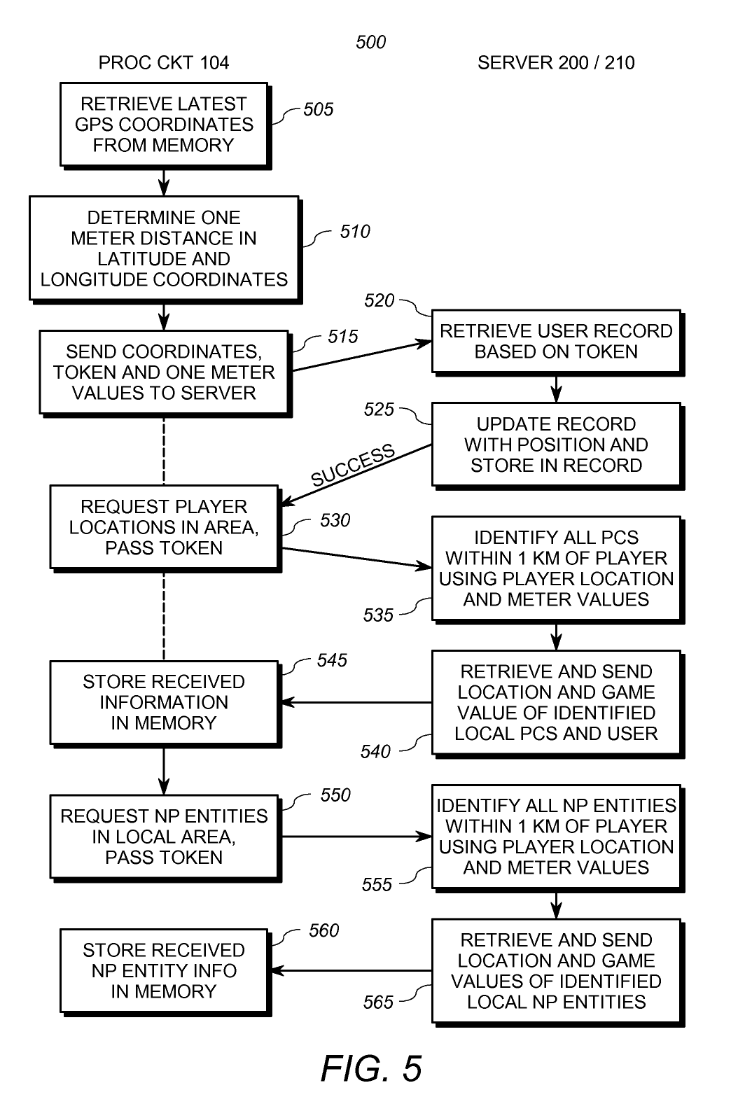

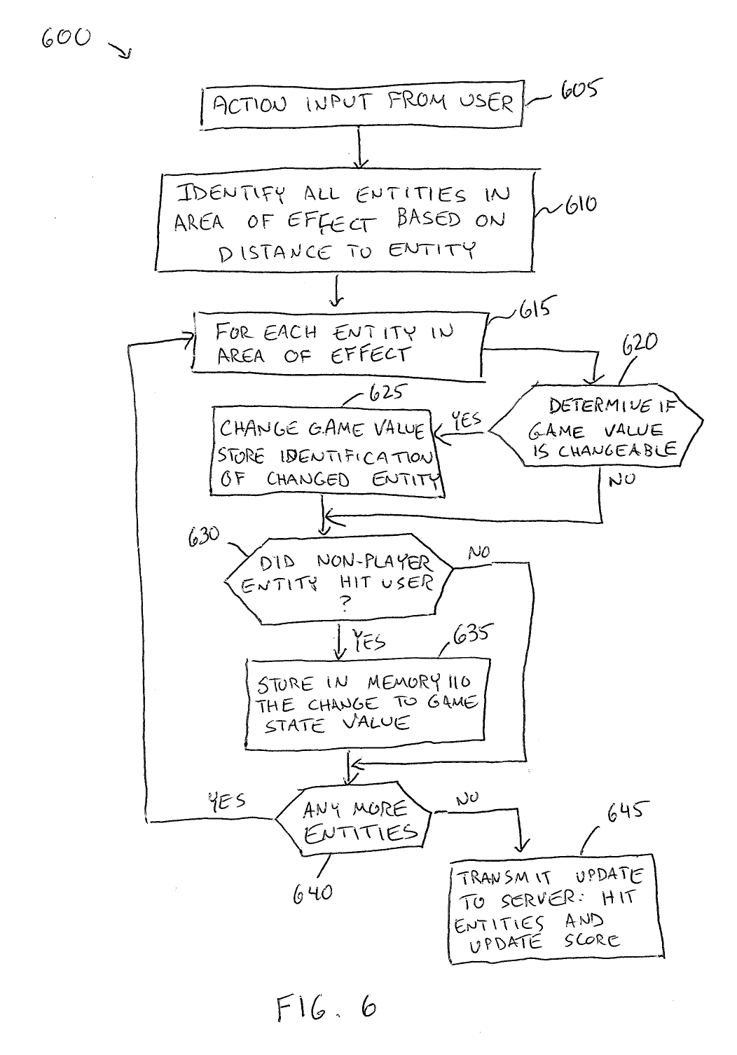

In step 335, the game server 200 transmits the values GSV, SCORE and TOKEN to the processing circuit 104. In step 340, the processing circuit 104 begins executing the main game operations of the application using the values GSV, SCORE and TOKEN. Specifically, the processing circuit in step 340 performs the operations of FIGS. 4, 5 and 6. These operations includes a local update 400 (FIG. 4), a remote update 500 (FIG. 5), and a pulse routine 600 (FIG. 6). The local update 400 includes updates to the user's GPS coordinates, the user's orientation, and the user's display 108. The remote update 500 updates the user's game state value and updates the locations of any other players in the vicinity of the user. The pulse routine 600 provides an update of any offensive/combat activity effectuated by the user. In general, the local update 400 occurs on a periodic basis, as does the remote update 500. The pulse routine 600 occurs whenever the user enters an input changing the game state value GSV or other value of another user or non-player entity. In some embodiments, another update may be pushed from the server 200 whenever the user is “hit” or “flipped” by another player.

Referring to FIG. 4, in the local update routine 400, the processing circuit 104 in step 405 erases the existing display and first renders the indicator 714 (see FIG. 7) of the area of influence or area of effect. Thereafter, the processing circuit 104 in step 410 queries the GPS unit 112 for the current GPS coordinates of the user. The processing circuit 104 stores the coordinates in the memory 110. After, during (or before) step 410, the processing circuit in step 415 obtains from the compass unit 170 the orientation information for the user. Accordingly, the processing circuit 104 has up to date information on the real-world location of the user, and the direction the user is facing (i.e. the user's orientation).

Steps 420 to 435 are then performed for each other entity (other players and non-player entities) stored within the local memory 110 of the device 100. As will be discussed below in connection with FIG. 5, the processing circuit 104 receives updates on the identity (state value such as team or faction value) and location of other entities within an area of interest from the server 200 from time to time. The game state values and locations of such other entities are stored in the memory 110.

Thus, for each such entity stored in the memory 110, in step 420, the processing circuit 104 obtains the last known geographical coordinates, and the game state value. In step 430, the processing circuit 104 calculates the distance and bearing from each entity to the user based on the user's GPS coordinates, the entity's geographical coordinates, and the orientation information for the user. Thereafter, in step 435, the processing circuit 104 renders the objects on the screen display 108 based on the calculated distance and bearing. In some embodiments, the processing circuit 104 also generates random movements for each non-playing entity stored in the memory 110, determines corresponding updated geographical coordinates for each entity, and stores the updated geographical coordinates in the memory 110.

In any event, in step 440, the processing circuit 104 returns to step 420 if there are more entities tracked in the memory 170 that have not yet been rendered and otherwise processed in steps 425, 430 and 435. If all of the entities have been rendered, the local update routine 400 is complete. The local update routine 400 then will be re-executed after a predetermined first time period of, for example, one second. However, shorter update times may be used based on improvements in processing time and load. Longer update times may also be used if necessary.

In any event, in order to limit the load on the game server 200, as well as to reduce the quantity of transmissions, it is preferable to perform the steps of local update routine 400 several times for every one occurrence of the remote update routine 500. For example, in one scenario, the local update routine 400 occurs approximately every second, and the remote update routine 500 occurs every 8 to 12 seconds. Thus, the game experience involves frequent changes (via the local update routine 400) without requiring a transmission to the remote server 200, and remote server 200 action, at the same update frequency.

Referring now to FIG. 5, the remote update routine 500 is shown. In step 505, the processing circuit 104 obtains the user's GPS coordinates from local memory 110. In step 510, the processing circuit 104 calculates the meter distance scale of longitude and latitude based on the physical location of the user. It is known that the distance to objects based on differences in latitude and longitude will vary based on the geographical location on the earth. In this embodiment of the invention, the distance calculations between the user (i.e. the wireless device 100) and other entities are corrected for the curvature of the earth. To this end, each user calculates the relationship of distance to latitude/longitude coordinates applicable to the user. The calculation comprises determining the latitude and longitude distance (in minutes and seconds) that corresponds to one meter. This value is known herein as the coordinate/meter conversion factor. The processing circuit 104 generates the coordinate/meter conversion factor using the great circle formula. The great circle formula may suitably assume a perfect sphere for simplicity of calculation, or take into account the spheroid nature of the earth for increased accuracy. The details of suitable calculations for both methods are widely available and would be known to those of ordinary skill in the art.

Thereafter, in step 515, the processing circuit 104 causes transmission of the coordinate/meter conversion values, the token value TOKEN, and the user's SCORE value to the game server 200.

In step 520, the game server 200 receives the transmission from step 515 and retrieves the user's record based on the token value TOKEN. Thereafter, in step 525, the game server 200 updates the user's record with any change in the SCORE value, the user's GPS location, and the meter/coordinate conversion value, and stores the updated data record 802 in the database 221 of the data store 220. Assuming the save was successful, the game server 200 transmits an acknowledgement of the successful save to the user's device in step 530. If, for some reason, the save is not successful, other action may be taken. The details of such other action may take any suitable form.

It will be appreciated that in some cases, it will not be necessary to transmit the user's SCORE value from the processing circuit 104 in step 515 because all changes in SCORE are associated with other actions, such as the pulse update routine 600 of FIG. 6.

In step 530, the processing circuit 104 receives the acknowledgement of the successful server save, and then transmits a request for entity locations in the area. The processing circuit 104 transmits the request along with the token value TOKEN.

In step 535, the game server 200 receives the entity location request and identifies all entities (player entities—those wireless devices 700, 800 running the application 251) within a predetermined distance (i.e. radius) area of the user's location. To this end, the game server 200 performs a search operation to determine all entities that have coordinates less than a predetermined number of meters away. In general, the game server 200 determines this based on the difference in geographical coordinates between each entity and the user, and using the conversion between meters and geographical coordinates provided by the processing circuit 104 in step 515.

In step 540, the game server 200 retrieves and sends to the processing circuit 104 the geographical coordinates, game state value, and optionally, score (and/or health value), of all entities identified in step 535. The game server 200 also provides the user's game state value, as the user's game state value may have been changed by another entity (e.g. wireless devices 700, 800 running the application 251).

In step 545, the processing circuit receives the data transmitted in step 540 and stores the information in the memory 110.

In step 550, the processing circuit 104 transmits a request for non-player entity locations in the area. The processing circuit 104 transmits the request along with the token value TOKEN. In this embodiment, the non-player entities have data records on the server similar to the data record 802, which include a state value and location information.

It will be appreciated that in an alternative some cases, the non-player entities are randomly generated at the user's device 100 based on predetermined parameters downloaded to the processing circuit 104 at the start of the session, such as in step 335. In such a case, all remaining movement and attack information regarding the non-player entities occurs locally on the device 100. In such a case, steps 550, 555 and 560 would not be necessary. However, the processing circuit 104 would also have the ability to generate new drone entities over a large area and store the drone state values and geographical locations in the memory 110. The generation of new drone entities would be based on the predetermined parameters. For example, the parameters may identify the population density of drones in the vicinity of the user. In such a case the, processing circuit 104 would maintain a list of non-playing entities, as discussed above in connection with step 420 of FIG. 4, but also update the list in the memory 110 based on movement of the user (i.e. requiring new non-playing entities) corresponding to the user's new physical location. The list would be updated to include new non-playing entities based on the population density parameters.

However, in the embodiment of FIG. 5, the non-player entities are persistent and stored in the server 200. Referring again to FIG. 5, in step 555, the game server 200 receives the entity location request and identifies all drones or non-player entities within a predetermined distance (i.e. radius) area of the user's location. To this end, the game server 200 in this embodiment implements persistent non-player entities in the database storage 220 with data records akin to those of the players. The database records may be similar to the record 802 of FIG. 8, but include only the game state value and geographical coordinates. If appropriate in other embodiments, the database records can include a health value and/or other special charateristics. Non-player entity data records would not require or include a TOKEN value, a score value, or a coordinate/meter conversion value.

It will be appreciated that as used herein, the non-player entities or drones are deemed to “exist” or be located at the geographical coordinates associated therewith. Accordingly, although a drone or non-player entity may not physically exist, it “exists” and has a real world location within the context of the game because of the geographical coordinates associated with it. Thus, for the purposes herein, a drone or non-player entity is said to be within a predetermined distance of the wireless device 100 when the distance, calculated based on the difference between the geographical coordinates of the drone and the geographical coordinates of the wireless device, is less than the predetermined distance.

Accordingly, in step 555, the game server 200 performs a search operation to determine all non-player entities that have coordinates less than a predetermined number of meters away. In general, the game server 200 determines this based on the difference in geographical coordinates between each entity and the user, and using the conversion between meters and geographical coordinates provided by the processing circuit 104 in step 515.

In step 560, the game server 200 retrieves and sends to the processing circuit 104 the geographical coordinates, game state value, and optionally, health value or other parameters, of all entities identified in step 555.

In step 565, the processing circuit receives the data transmitted in step 560 and stores the information in the memory 110.

FIG. 6 shows a pulse update operation 600 that is performed each time a user enters an input to change the state of entities within the range of influence. Accordingly, in step 605, the processing circuit 104 receives an action input via the input device 114, which triggers the ensuing operations. For example, such an input can be detected when the user touches the screen 108 at “pulse” icon 716 of FIG. 7. After step 605, the processing circuit 104 proceeds to step 610.

In step 610, the processing circuit 104 identifies all entities in area of effect (which corresponds to icons for entities being within the indicator 714) based on the distance to the entity. To this end, for each entity stored in the memory 110, the processing circuit 104 determines whether the entity is within a predetermined distance of the wireless device 100 based on the wireless device geographical coordinates and the geographical coordinates of the entity. The calculation may also take into account the coordinate/meter conversion value for the device 100. The predetermined distance corresponds to the indicator 714. All entities within the indicator 714 of FIG. 7 are within the predetermined distance, and thus within the area of effect.

In step 615, the processing circuit 104 starts a loop to be performed for each of the identified entities in the area of effect. The loop starts at step 620 for the first entity, and repeats for each other identified entity.

In step 620, the processing circuit 104 determines whether the game state value of the entity is changeable based on various game factors. To this end, in some versions of the game, the user cannot change the members of its own faction/team. In other versions, certain entities may have defenses or immunities. Accordingly, in such cases, step 620 may use a probability value (either predetermined, or adjustable, for example, by enhancements purchased by the user) to determine if the particular entity has been “hit”. If the entity is changeable and/or hit, then the game state value of the entity is changed and stored locally in step 625. After step 625, the processing circuit 104 proceeds to step 630.

If, however, the processing circuit 104 determines that the game state value of the entity is not changeable, or has not been hit, then the processing circuit 104 proceeds directly to step 630.

In step 630, at least in one embodiment of the invention, the processing circuit 104 determines whether the current entity is a non-player entity and if so, whether that non-player entity has successfully attacked the user. If the entity being processed is another player (as opposed to a non-playing entity), then the processing circuit proceeds directed to step 640. However, assuming the current entity is a non-player entity, it will be appreciated that every non-player entity has a probability of flipping (or injuring in the embodiment in which the user has a health value that is diminished) the user when the non-player entity is within the area of effect (as indicated by the indicator 714 of FIG. 7). The probability may be a predetermined and permanent value built into the application 251, or may be a dynamic value obtained from the non-player entity record retrieved in step 560, which is provided to the processing circuit 104 in step 565. Thus, the processing circuit 104 determines randomly, based on the predetermined probability, if the user has been “hit” by the non-player entity. If the user has been successfully attacked by the current non-player entity, then the processing circuit 104 proceeds to step 635. If not, then the processing circuit 104 proceeds to step 640 to continue the loop with the next identified entity.

In step 635, the processing circuit 104 stores locally in the memory 110 a new game state value based on the successful hit. In the case where no “health” value is maintained, then the new game state value will indicate that the user has been “flipped” to the other “team”. The user's score value is also reset to zero (or otherwise adjusted downward), and the ammunition value may be replenished. The processing circuit 104 may then proceed directly to step 645. However, in an embodiment where the user has a “health” value that is diminished, but not extinguished (set to zero), by the successful hit of step 630, the processing circuit 104 would instead adjust the health value of the user as stored locally in the memory 110 and proceed to step 640.

In step 640, the processing circuit 104 determines if there are further entities in the area of effect (within indicator 714 of FIG. 7) to process. If not, and all entities identified in step 610 have been processed, then the processing circuit 104 proceeds to step 645. If so, however, then the processing circuit 104 returns to step 615 to start processing the next such entity.

In step 645, the processing circuit 104 transmits updated values of all entities to the game server 200. Although not shown, the server processor 210 retrieves the user's data record 802 and stores any changes thereto. Store changes can include those resulting from the user being “hit” or “flipped”. Being “hit” results in a change of game state value, ammunition, score (or optionally health). The server processor 210 would also store any change to the user's score value in the event that the user successfully hit or flipped another entity as per step 625. In either event, the updated data record 802 for the user is thereafter stored in the database 221. In addition, the processing circuit 104 further transmits an indication of any player entities that had been hit as determined in step 625. The server processor 210 receives these values and updates the respective other player's data records in the database 221 accordingly. It will be appreciated that the other players wireless devices may be updated to incorporate such damage (or flipping) in a number of ways. For example, the server 200 may suitably push a notification that a player has been damaged to that other player's device (e.g. wireless devices 700, 800) in real time. Alternatively, a player may be notified that he or she has been damaged or flipped as another part uploaded data in step 525 or step 540 of FIG. 5.

It will also be appreciated that the operations of step 630 and 635 may be incorporated in to the routine of FIG. 4. In other words, instead of determining whether the user has been “hit” by a non-player entity after a pulse event that initiates the operations of FIG. 6, the determination may occur whenever the screen 702 is updated as per FIG. 4.

In any event, it will be appreciated that the above-described embodiment thus provides an interactive game that can be played by multiple players, or by a single player, and which involves movement of the user for play. The selection and allocation of the various processing tasks in this embodiment have been selected to reduce the load on the wireless network and the server processor 200, allowing for large numbers of players without requiring excessive resources.

Various embodiments may be implemented with the core technology disclosed herein. For example, it will be appreciated that in some versions of the game, particularly those where entities have “health” points that must be extinguished to change the game state value, the processing circuit 104 only provides information about hits or damage to entities identified in step 610. In such a case, the hit or damage information is transmitted in step 645, and the game server 200 may suitably track and update the health of the entities.

It will be appreciated that while the locations and geographical coordinates determined within the wireless device 100 and the server processor 200 are approximate, limited by the accuracy of the GPS technology, among other things.

We claim:

1. A method comprising:
a) transmitting from a wireless device first location information, the first location information comprising information indicating a real-world physical location of the wireless device;
b) receiving at a wireless device update data, the update data including first information comprising location information for a plurality of entities in a real world coordinate system, the update further comprising a state value for each of the plurality of entities;
c) rendering on a display of the wireless device a representation of the location and state value of the plurality of entities in a real-world coordinate system in relation to the real-world physical location of the wireless device;
d) receiving a user input at the wireless device, and generating second information therefrom;
e) transmitting the second information to a remote device, the second information providing state value change information relating to at least one of the plurality of entities.

2. The method of claim 1, wherein step a) further comprises determining within the wireless device an approximate real-world physical location of the wireless device.

3. The method of claim 2, wherein step a) further comprises obtaining global positioning satellite information from within the wireless device and determining the physical location of the wireless device based on the global positioning satellite information.

4. The method of claim 1, further comprising determining if a distance defined by location information of a first entity of the plurality of entities and the first location information is within a predetermined distance, and wherein step d) further comprises generating the second information at least in part based on said determination.

5. A wireless device, comprising:
a wireless transmitter;
a display;
a memory;
a processing circuit configured to:
cause the wireless device to transmit first location information, the first location information comprising information indicating a real-world physical location of the wireless device;
receive from the wireless device update data transmitted by a remote device, the update data including first information comprising location information for a plurality of entities in a real world coordinate system, the update data further comprising a state value for each of the plurality of entities;
render on the display a representation of the location and state value of the plurality of entities in a real-world coordinate system in relation to the real-world physical location of the wireless device;
receive a user input at the wireless device, and generate second information therefrom;
cause the wireless device to transmit the second information to the remote device, the second information providing state value change information relating to at least one of the plurality of entities.
